(19) United States
(12) Patent Application Publication
(10) Pub. No.: US 2021/0124315 A1
(43) Pub. Date: Apr. 29, 2021

(54) Method For Designing PID Controller (as amended)

(71) Applicant: Foshan University, Foshan City (CN)

(72) Inventors: Ying LUO, Foshan City (CN); Weijia ZHENG, Foshan City (CN)

(73) Assignee: Foshan University, Foshan City (CN)

(21) Appl. No.: 16/760,341

(22) PCT Filed: Dec. 28, 2018
(86) PCT No.: PCT/CN2018/124637

§ 371 Date: Apr. 29, 2020

(30) Foreign Application Priority Data
Aug. 3, 2018 (CN) 201810876468.5

(51) Int. Cl. G05B 13/04; G05B 11/42; G05B 21/02; G06F 17/14

(52) U.S. Cl. CPC G05B 13/042; G06F 17/14; G05B 21/02; G05B 11/42

(57) ABSTRACT

Disclosed is a method for designing a PID controller, having a control model

$$C ( s ) = {K}_{P} ( 1 + \frac{{K}_{I}}{{S}^{λ}} + {K}_{D} {S}^{u} ) ,$$

wherein K_{D}=aK_{I}, and u=bλ, a and b are proportional coefficients, the control model is reset as

$$C ( s ) = {K}_{P} ( 1 + \frac{{K}_{I}}{{S}^{λ}} + {aK}_{I} {S}^{b λ} ) ,$$

a transfer function of a controlled object in a control system is set as

$$G ( s ) = \frac{K}{{s}^{3} + {τ}_{1} {s}^{2} + {τ}_{2} s} .$$

The method comprises selecting a cut-off frequency ω_{c} and a phase margin φₘ of the control system; obtaining values of the proportional coefficients a and b, according to an optimal proportion model of control model parameters of the fractional order PID controller, and according to the cut-off frequency ω_{c} and the phase margin φₘ; calculating amplitude information and phase information of the transfer function at the cut-off frequency ω_{c}; obtaining two equations related to an integral gain K_{I} and a fractional order λ; solving the integral gain K_{I} and the fractional order λ; solving a differential gain K_{D} and a fractional order u; and calculating a proportional gain K_{P}. According to the invention, by establishing a proportional relationship between the integral gain K_{I} and the differential gain K_{D} of the fractional order PID controller as well as a proportional relationship between the integral order λ and the differential order u, the freedom degree of parameters of the fractional order PID controller and consequently the difficulty in parameter setting are reduced.

### TECHNICAL FIELD

The present disclosure relates to the technical field of PID controllers.

### BACKGROUND

At present, a conventional feedback control method based on an output error, which is mainly realized by a PID controller, is widely used in a servo system. The conventional PID controller has a control model, as shown in equation 1:

$$C ( s ) = {K}_{P} ( 1 + \frac{{K}_{I}}{s} + {K}_{D} s ) , \qquad equation 1$$

wherein, K_{P} is a proportional gain, K_{I} is an integral gain, K_{D} is a differential gain, and s is a Laplace operator.

The conventional PID controller has the advantages of simple structure and easy realization. However, the control model of the conventional PID controller is prone to some problems, such as excessive overshoot and excessive adjustment time, unable to meet the performance requirements of high-performance motion control systems.

As to the problems described above, those skilled in the art improved the control model of the PID controller, and the resulting control model of the PID controller is shown in equation 2:

$$C ( s ) = {K}_{P} ( 1 + \frac{{K}_{I}}{{s}^{λ}} + {K}_{D} {s}^{u} ) , \qquad equation 2$$

wherein λ and u are fractional orders. It is found by previous studies that, better control performance can be obtained by using the fractional order PID controller for the servo system than using the integral order PID controller. However, there is no universally accepted principle or method for setting parameters for the fractional-order controller. Therefore, it is more difficult to design the fractional order PID controller than the integral order PID controller.

At present, the parameter setting methods for the fractional-order PID controller are mainly classified into two groups: frequency domain design methods and time-domain optimization algorithms. With a frequency domain design method, parameters of the fractional-order controller are solved according to a robustness criterion through gain cross-over frequency and a phase margin of a specified system. With the time-domain optimization algorithm, the parameters of the controller are searched according to a given dynamic performance index.

With the frequency-domain design method, the parameters of the fractional-order controller are solved according to the robustness criterion through the gain cross-over frequency and the phase margin of the specified system, the obtained fractional order controller can ensure the robustness of the system to open-loop gain disturbance. However, the existing frequency domain design method cannot be directly applied to the design of the fractional-order PID controller. Moreover, since there is no clear criterion or method for selecting the gain cross-over frequency and the phase margin, the frequency domain design method cannot ensure the optimal dynamic response performance of the control system. With the time-domain optimization algorithm, the parameters of the controller are searched according to the given dynamic performance index, and the obtained controller can enable the system to achieve a good step response following performance, but cannot ensure that the system can have good stability and robustness to gain disturbance. Meanwhile, a lot of numerical calculation is required for the time domain optimization algorithm in use to search the parameters of the controller, which is not conducive to practical applications.

### SUMMARY

A technical problem the present disclosure aims to solve can be identified as: how to simplify the parameter setting process of a PID controller while ensuring the servo system applied on the PID controller meeting the requirements of stability and robustness.

An exemplary technical solution adopted in the present disclosure to solve the technical problem is as follows.

In a method for designing a PID controller, comprises setting a control model of a PID controller, as equation 2:

$$C ( s ) = {K}_{P} ( 1 + \frac{{K}_{I}}{{s}^{λ}} + {K}_{D} {s}^{u} ) , \qquad equation 2$$

wherein, K_{P} is a proportional gain, K_{I} is an integral gain, K_{D} is a differential gain, λ is an integral fractional-order, u is a differential fractional-order, and s is a Laplace operator; and

setting K_{D}=aK_{I}, and u=bλ in equation 2, wherein a and b are proportional coefficients, and the control model of the PID controller is reset as equation 3:

$$C ( s ) = {K}_{P} ( 1 + \frac{{K}_{I}}{{S}^{λ}} + {aK}_{I} {s}^{b λ} ) , \qquad equation 3$$

and

a transfer function of a controlled object in a control system is set as equation 4:

$$G ( s ) = \frac{K}{{s}^{3} + {τ}_{1} {s}^{2} + {τ}_{2} s} , \qquad equation 4$$

wherein τ₁, τ₂, and K are the model parameters of the object.

The method further comprises the following steps 1-7.

Step 1: selecting a cut-off frequency ω_{c} and a phase margin φₘ of the control system.

Step 2: obtaining the values of the proportional coefficients a and b, according to the cut-off frequency ω_{c} and the phase margin φₘ, and according to an optimal proportion model of control model parameters of the fractional order PID controller.

Step 3: calculating the amplitude information and phase information of the transfer function at the cut-off frequency ω_{c} respectively according to equation 5 and equation 6, wherein equation 5 and equation 6 are as follows:

$$\begin{matrix}\vert G ( j {ω}_{c} ) \vert = \frac{K}{\sqrt{{A ( {ω}_{c} )}^{2} + {B ( {ω}_{c} )}^{2}}} , and & equation 5 \\ Arg \vert G ( j {ω}_{c} ) \vert = - arctan [ \frac{G ( {ω}_{c} )}{A ( {ω}_{c} )} ] , & equation 6\end{matrix}$$

wherein, A(ω)=−τ₁ω² and B(ω)=τ₂ω−ω³.

Step 4: obtaining two equations related to the integral gain K_{I} and the fractional-order λ according to the proportional coefficients a and b obtained in the step 2, wherein the two equations are shown as equation 7 and equation 8:

$$\begin{matrix}{K}_{I} = \frac{- M}{\begin{matrix}M {ω}_{c}^{- λ} cos ( \frac{λ π}{2} ) + aM {ω}_{c}^{b λ} cos ( \frac{b λ π}{2} ) + \\ aN {ω}_{c}^{b λ} sin ( \frac{b λ π}{2} ) - N {ω}_{c}^{- λ} sin ( \frac{λ π}{2} )\end{matrix}} , and & equation 7 \\ {Q}_{2} {K}_{I}^{2} + {Q}_{1} {K}_{I} + Z = 0 , & equation 8\end{matrix}$$

wherein, M=A(ω_{c})tan(−π+φₘ)+B(ω_{c}) and N=B(ω_{c})tan(−π+φₘ)−A(ω_{c}) in the equation 7, and

$${{Q}_{2} = \frac{a ( 1 + b ) λ}{{ω}_{c}^{1 + ( 1 - b ) λ}} sin ( \frac{( b + 1 ) λ π}{2} ) + 2 aZ {ω}_{c}^{( b - 1 ) λ} cos ( \frac{( b + 1 ) λ π}{2} ) + {a}^{2} Z {ω}_{c}^{2 b λ} + Z {ω}_{c}^{- 2 λ} , \\ {Q}_{1} ab λ {ω}_{c}^{b λ - 1} sin ( \frac{b λ π}{2} ) + λ {ω}_{c}^{- λ - 1} sin ( \frac{λ π}{2} ) + 2 aZ {ω}_{c}^{b λ} cos ( \frac{b λ π}{2} ) + 2 Z {ω}_{c}^{- λ} cos ( \frac{λ π}{2} ) and \\ Z = \frac{d [ Arg [ G ( j ω ) ] ]}{d ω} \vert}_{ω = {ω}_{c}} in equation 8.$$

Step 5: solving the integral gain K_{I} and the fractional-order λ according to equation 7 and equation 8.

Step 6: solving the differential gain K_{D} and the fractional-order u according to a relationships K_{D}=aK_{I} and u=bλ; and

Step 7: calculating the proportional gain K_{P} according to equation 9 as follows:

$$\begin{matrix}{K}_{P} = \frac{\sqrt{{A ( {ω}_{c} )}^{2} + {B ( {ω}_{c} )}^{2}}}{K \sqrt{{P ( {ω}_{c} )}^{2} + {Q ( {ω}_{c} )}^{2}}} , & equation 9 \\ wherein , & \\ P ( ω ) = 1 + {K}_{I} {ω}^{- λ} cos ( \frac{λ π}{2} ) + {K}_{D} {ω}^{u} cos ( \frac{u π}{2} ) and & \\ Q ( ω ) = {K}_{D} {ω}^{u} cos ( \frac{u π}{2} ) - {K}_{I} {ω}^{- λ} sin ( \frac{λ π}{2} ) . & \end{matrix}$$

The present disclosure has the beneficial effects including: according to the present disclosure, the freedom degree of the parameters of the fractional order PID controller is reduced and thus the difficulty in parameter setting is reduced, by establishing a proportional relationship between the integral gain Kr and the differential gain K_{D} of the fractional order PID controller as well as a proportional relationship between the integral order λ and the differential order u.

### BRIEF DESCRIPTION OF THE DRAWINGS

In order to illustrate the embodiments of the invention more clearly, the drawings to be used in the description of the embodiments will be briefly described below. Obviously, the described drawings merely show some of the embodiments of the invention, rather than all the embodiments. Those skilled in the art can envisage other embodiments and drawings based on these drawings without going through any creative effort.

FIG. 1 is a flow chart of a method according to the present disclosure.

### DETAILED DESCRIPTION

The concepts, the specific structures and the technical effects produced by the invention will be described in detail in conjunction with the embodiments and the accompanying drawings, for a reader to sufficiently understand the objects, features and effects of the invention. Obviously, the described embodiments are merely some of the embodiments of the invention. Other embodiments that may be envisaged by those skilled in the art without going through any creative effort shall all fall within the protection scope of the invention.

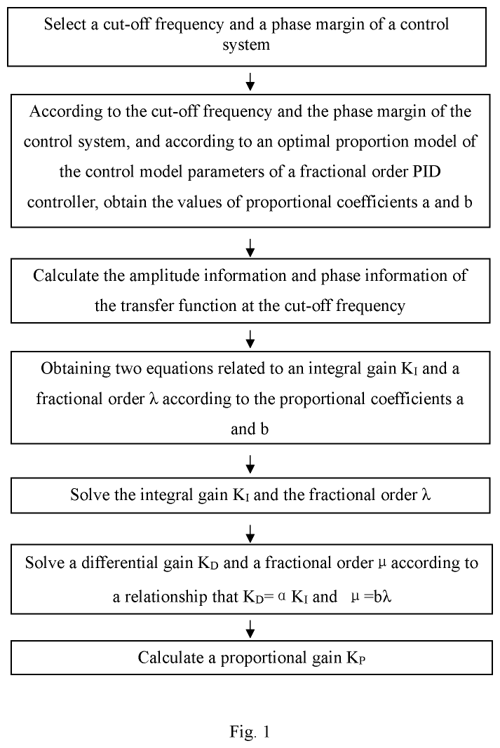

Referring to FIG. 1, in the present disclosure a method for designing a PID controller is disclosed. The PID controller has a control model which is set as equation 2:

$$C ( s ) = {K}_{P} ( 1 + \frac{{K}_{I}}{{s}^{λ}} + {K}_{D} {s}^{u} ) , \qquad equation 2$$

wherein, K_{P} is a proportional gain, K_{I} is an integral gain, K_{D} is a differential gain, λ is a fractional-order, u is a fractional-order, and s is a Laplace operator;

making K_{D}=aK_{I}, and u=bλ in equation 2, wherein a and b are proportional coefficients, and the control model of the PID controller can be modified as equation 3:

$$C ( s ) = {K}_{p} ( 1 + \frac{{K}_{I}}{{s}^{λ}} + {aK}_{I} {s}^{b λ} ) , \qquad equation 3$$

a transfer function of a controlled object in a control system is set as equation 4:

$$G ( s ) = \frac{K}{{s}^{3} + {τ}_{1} {s}^{2} + {τ}_{2} s} , \qquad equation 4$$

wherein τ₁, τ₂, and K are model parameters of the object; and

the method comprises the following steps of:

step 1: selecting a cut-off frequency ω_{c} and a phase margin φₘ of the control system;

step 2: obtaining the values of the proportional coefficients a and b, according to an optimal proportion model of the control model parameters of the fractional order PID controller, and according to the cut-off frequency ω_{c} and the phase margin φₘ;

step 3: calculating amplitude information and phase information of the transfer function at the cut-off frequency co, respectively according to equation 5 and equation 6, wherein equation and equation 6 are as follows:

$$\begin{matrix}\vert G ( j {ω}_{c} ) \vert = \frac{K}{\sqrt{{A ( {ω}_{c} )}^{2} \div {B ( {ω}_{c} )}^{2}}} & equation 5 \\ Arg \vert G ( j {ω}_{c} ) \vert = - arctan [ \frac{B ( {ω}_{c} )}{A ( {ω}_{c} )} ] & equation 6\end{matrix}$$

wherein, A(ω)=−τ₁ω² and B(ω)=τ₂ω−ω³;

step 4: obtaining two equations related to the integral gain K_{I} and the fractional order λ according to the proportional coefficients a and b obtained in step 2, which are respectively shown as equation 7 and equation 8:

$$\begin{matrix}{K}_{I} = \frac{- M}{\begin{matrix}M {ω}_{c}^{- λ} cos ( \frac{λπ}{2} ) + aM {ω}_{c}^{b λ} cos ( \frac{b λπ}{2} ) + \\ aN {ω}_{c}^{b λ} sin ( \frac{b λπ}{2} ) - N {ω}_{c}^{- λ} sin ( \frac{λπ}{2} )\end{matrix} } , and & equation 7 \\ {Q}_{2} {K}_{I}^{2} + {Q}_{1} {K}_{I} + Z = 0 & equation 8 \\ & \end{matrix}$$

wherein, M=A(ω_{c})tan(−π+φₘ)+B(ω_{c}) and N=B(ω_{c})tan(−π+φₘ)−A(ω_{c}) in equation 7, and

$${{Q}_{2} = \frac{a ( 1 + b ) λ}{{ω}_{c}^{1 + ( 1 - b ) λ}} sin ( \frac{( + 1 ) λπ}{2} ) + 2 aZ {ω}_{c}^{( b - 1 ) λ} cos ( \frac{( b + 1 ) λπ}{2} ) + {a}^{2} Z {ω}_{c}^{2 b λ} + Z {ω}_{c}^{- 2 λ} , \\ {Q}_{1} = ab {λω}_{c}^{b λ - 1} sin ( \frac{bλπ}{2} ) + {λω}_{c}^{- λ - 1} sin ( \frac{λπ}{2} ) + 2 aZ {ω}_{c}^{b λ} cos ( \frac{b λπ}{2} ) + 2 Z {ω}_{c}^{- λ} cos ( \frac{λπ}{2} ) and \\ Z = \frac{d [ Arg [ G ( j ω ) ] ]}{d ω} \vert}_{ω = {ω}_{c}} in equation 8 ;$$

step 5: solving the integral gain K_{I} and the fractional order λ according to equation 7 and equation 8;

step 6: solving the differential gain K_{D} and the fractional order u according to the relationships K_{D}=aK_{I} and u=bλ; and

step 7: calculating the proportional gain K_{P} according to equation 9 as follows:

$$\begin{matrix}{K}_{P} = \frac{\sqrt{{A ( {ω}_{c} )}^{2} + {B ( {ω}_{c} )}^{2}}}{K \sqrt{{P ( {ω}_{c} )}^{2} + {Q ( {ω}_{c} )}^{2}}} , & equation 9 \\ wherein , \\ P ( ω ) = 1 + {K}_{1} {ω}^{- λ} cos ( \frac{λπ}{2} ) + {K}_{D} {ω}^{u} cos ( \frac{u π}{2} ) and \\ Q ( ω ) = {K}_{D} {ω}^{u} cos ( \frac{u π}{2} ) - {K}_{I} {ω}^{- λ} sin ( \frac{λπ}{2} ) . & \end{matrix}$$

Specifically, according to the present disclosure, by establishing a proportional relationship between the integral gain K_{I} and the differential gain K_{D} of the fractional-order PID controller, as well as a proportional relationship between the integral order λ and the differential order u, the freedom degree of parameters of the fractional-order PID controller is reduced, and consequently the difficulty in parameter setting is reduced.

In order to more sufficiently explain the specific process of the method for establishing the optimal proportion model of parameters of the PID controller according to the present disclosure, hereafter a parameter setting process of the fractional-order PID controller applied to a permanent magnet synchronous motor servo system is described.

A transfer function of a speed loop control object of the servo system is set as

$$G ( s ) = \frac{47979.2573}{{s}^{3} + 127.38 {s}^{2} + 995.678 s} ,$$

a cut-off frequency is set as ω_{c}=60 rad/s, a phase margin is set as φₘ=60 deg, a proportional coefficient is set as a=7.553×10⁻⁴, and a proportional coefficient is set as b=1.253, according to the actual application conditions. Going through each of the steps of the method described above, a control model of a PID controller of the servo system obtained by calculations is shown as follows:

$$C ( s ) = 11.4944 ( 1 + \frac{13.0838}{{s}^{0.8489}} + 0.0099 {s}^{1.0637} )$$

The foregoing describes the preferred embodiments of the invention in detail, but the invention is not limited to the embodiments, those skilled in the art can also make various equal modifications or replacements without departing from the spirit of the invention, and these equal modifications or replacements shall all fall within the scope limited by the claims of the invention.

1. A method for designing a PID controller, comprising:
setting a control model of the PID controller, as equation 2:
$$C ( s ) = {K}_{p} ( 1 + \frac{{K}_{I}}{{s}^{λ}} + {K}_{D} {s}^{u} ) , \qquad equation 2$$
wherein, K_{P} is a proportional gain, K_{I} is an integral gain, K_{D} is a differential gain, λ is a fractional-order, u is a fractional-order, and s is a Laplace operator;
resetting the control model of the PID controller by setting K_{D}=aK_{I}, and u=bλ in equation 2, wherein a and b are proportional coefficients, as equation 3:
$$C ( s ) = {K}_{p} ( 1 + \frac{{K}_{I}}{{s}^{λ}} + {aK}_{I} {s}^{b λ} ) , \qquad equation 3$$
setting a transfer function of a controlled object in a control system, as equation 4:
$$G ( s ) = \frac{K}{{s}^{3} + {τ}_{1} {s}^{2} + {τ}_{2} s} , \qquad equation 4$$
wherein τ₁, τ₂, and K are model parameters of the object; and
the method further comprising the following steps of:
step 1: selecting a cut-off frequency ω_{c} and a phase margin φₘ of the control system;
step 2: obtaining values of the proportional coefficients a and b, according to an optimal proportion model of control model parameters establishing the fractional order PID controller, and according to the cut-off frequency ω_{c} and the phase margin φₘ of the control system;
step 3: calculating amplitude information and phase information of the transfer function at the cut-off frequency ω_{c}, respectively, according to equation 5 and equation 6:
$$\begin{matrix}\vert G ( j ω ) \vert = \frac{K}{\sqrt{{A ( {ω}_{c} )}^{2} + {B ( {ω}_{c} )}^{2}}} , and & equation 5 \\ Arg \vert G ( j {ω}_{c} ) \vert = - arctan [ \frac{B ( {ω}_{c} )}{A ( {ω}_{c} )} ] , & equation 6\end{matrix}$$
wherein, A(ω)=−τ₁ω² and B(ω)=τ₂ω−ω³;
step 4: obtaining two equations related to the integral gain K_{I} and the fractional-order λ according to the proportional coefficients a and b obtained in the step 2:
$$\begin{matrix}{K}_{I} = \frac{- M}{M {ω}_{c}^{- λ} cos ( \frac{λπ}{2} ) + aM {ω}_{c}^{b λ} cos ( \frac{b λπ}{2} ) + aN {ω}_{c}^{b λ} sin ( \frac{b λπ}{2} ) - N {ω}_{c}^{- λ} sin ( \frac{λπ}{2} )} , & equation 7 \\ and & \\ {Q}_{2} {K}_{I}^{2} + {Q}_{1} {K}_{I} + Z = 0 & equation 8\end{matrix}$$
wherein, M=A(ω_{c})tan(−π+φₘ)+B(ω_{c}) and N=B(ω_{c})tan(−π+φₘ)−A(ω_{c}), in equation 7, and
$${Q}_{2} = \frac{a ( 1 + b ) λ}{{ω}_{c}^{1 + ( 1 - b ) λ}} sin ( \frac{( b + 1 ) λπ}{2} ) + 2 aZ {ω}_{c}^{( b - 1 ) λπ} cos ( \frac{( b + 1 ) λπ}{2} ) + {a}^{2} Z {ω}_{c}^{2 b λ} + Z {ω}_{c}^{- 2 λ} , \\ {Q}_{1} = ab {λω}_{c}^{b λ - 1} sin ( \frac{b λπ}{2} ) + λ {ω}_{c}^{- λ - 1} sin ( \frac{λπ}{2} ) + 2 aZ {ω}_{c}^{b λ} cos ( \frac{b λπ}{2} ) + 2 Z {ω}_{c}^{- λ} cos ( \frac{ λπ}{2} ) and , \\ Z = {\vert \frac{d [ Arg [ G ( j ω ) ] ]}{d ω} \vert}_{ω = {ω}_{c}} in equation 8 ;$$
step 5: solving the integral gain K_{I} and the fractional-order λ according to equation 7 and equation 8;
step 6: solving the differential gain K_{D} and the fractional-order u according to relationships K_{D}=aK_{I} and u=bλ; and
step 7: calculating the proportional gain K_{P} according to equation 9 as follows:
$$\begin{matrix}{K}_{P} = \frac{\sqrt{{A ( {ω}_{c} )}^{2} + {B ( {ω}_{c} )}^{2}}}{K \sqrt{{P ( {ω}_{c} )}^{2} + {Q ( {ω}_{c} )}^{2}}} , & equation 9 \\ wherein , \\ P ( ω ) = 1 + {K}_{1} {ω}^{- λ} cos ( \frac{λπ}{2} ) + {K}_{D} {ω}^{u} cos ( \frac{u π}{2} ) and \\ Q ( ω ) = {K}_{D} {ω}^{u} cos ( \frac{u π}{2} ) - {K}_{I} {ω}^{- λ} sin ( \frac{λπ}{2} ) . & \end{matrix}$$
